(19) United States
(12) Patent Application Publication
(10) Pub. No.: US 2018/0213905 A1
(43) Pub. Date: Aug. 2, 2018

(54) TOOL BAG

(71) Applicant: Fieldpiece Instruments, Inc., Orange, CA (US)

(72) Inventors: James Louis Gregorec, Orange, CA (US); Jason Paul Belaire, Englewood, CO (US)

(73) Assignee: Fieldpiece Instruments, Inc., Orange, CA (US)

(21) Appl. No.: 15/882,596

(22) Filed: Jan. 29, 2018

Related U.S. Application Data
(60) Provisional application No. 62/451,531, filed on Jan. 27, 2017.

(51) Int. Cl. A45C 13/02; B25H 3/04; B25H 3/06; A45F 3/02; B65D 33/06

(52) U.S. Cl. CPC A45C 13/02; B25H 3/04; B25H 3/06; F16B 2001/0035; B65D 33/06; A45C 2013/026; A45F 2200/0575; A45F 3/02

(57) ABSTRACT

A tool bag includes an interior tool rack for easy access and good visibility to tools as well as a magnetic tray for securing parts removed during equipment servicing and an easy to carry single strap system that holds a fully loaded bag snugly to the body to enable carrying the bag in tight places such as crawl spaces and ladder cages.

This application claims priority to U.S. Provisional Application 62/451,531, filed Jan. 27, 2017.

### FIELD OF THE INVENTIONS

The inventions described below relate to the field of bags for organizing and transporting tools.

### SUMMARY

The devices and methods described below provide for a tool bag with a rigid interior tool organizer/rack for easy access and good visibility to tools as well as a magnetic tray for securing parts removed during equipment servicing and an easy to carry single strap system that holds a fully loaded bag snugly to the body to enable carrying the bag in tight places such as crawl spaces and ladder cages.

The rigid tool organizer/rack provides structure to the tool bag. The single strap system supports the bag with a primary strap from the top center of the bag and a first corner and enables ergonomically carrying the bag using the primary strap on a single shoulder with a secondary strap securing a second corner to the primary strap.

### BRIEF DESCRIPTION OF THE DRAWINGS

FIG. 1 is a perspective view of the tool bag with the main compartment opened to reveal the tool organizer/rack.

FIG. 2 is a perspective view of the tool organizer/rack.

FIG. 3 is a front perspective view of the tool bag of FIG. 1.

FIG. 4 is a rear perspective view of the tool bag of FIG. 1.

FIG. 5 is a top view of the tool bag of FIG. 1.

FIG. 6 is a front view of the tool bag of FIG. 1.

FIG. 7 is a view of the right side of the tool bag of FIG. 1.

FIG. 8 is a view of the left side of the tool bag of FIG. 1.

FIG. 9 is a cross-section view of the tool bag of FIG. 6 taken along A-A.

FIG. 10 is a top view of the tool bag of FIG. 1 with the tool organizer/rack of FIG. 2 illustrated in phantom.

FIG. 11 is a front view of the tool bag of FIG. 1 with the tool organizer/rack of FIG. 2 illustrated in phantom.

FIG. 12 is a cross-section view of the tool bag of FIG. 10 taken along B-B.

FIG. 13 is a top view of the tool organizer/rack of FIG. 2.

FIG. 14 is a side view of the tool organizer/rack of FIG. 2.

FIG. 15 is a front view of the tool organizer/rack of FIG. 2.

FIG. 16 is a top view of the tool tray of the tool organizer/rack of FIG. 2.

FIG. 17 is a front view of the tool tray of FIG. 16.

FIG. 18 is a side view of the tool tray of FIG. 16.

FIG. 19 is a perspective view of the tool tray of FIG. 16.

### DETAILED DESCRIPTION OF THE INVENTIONS

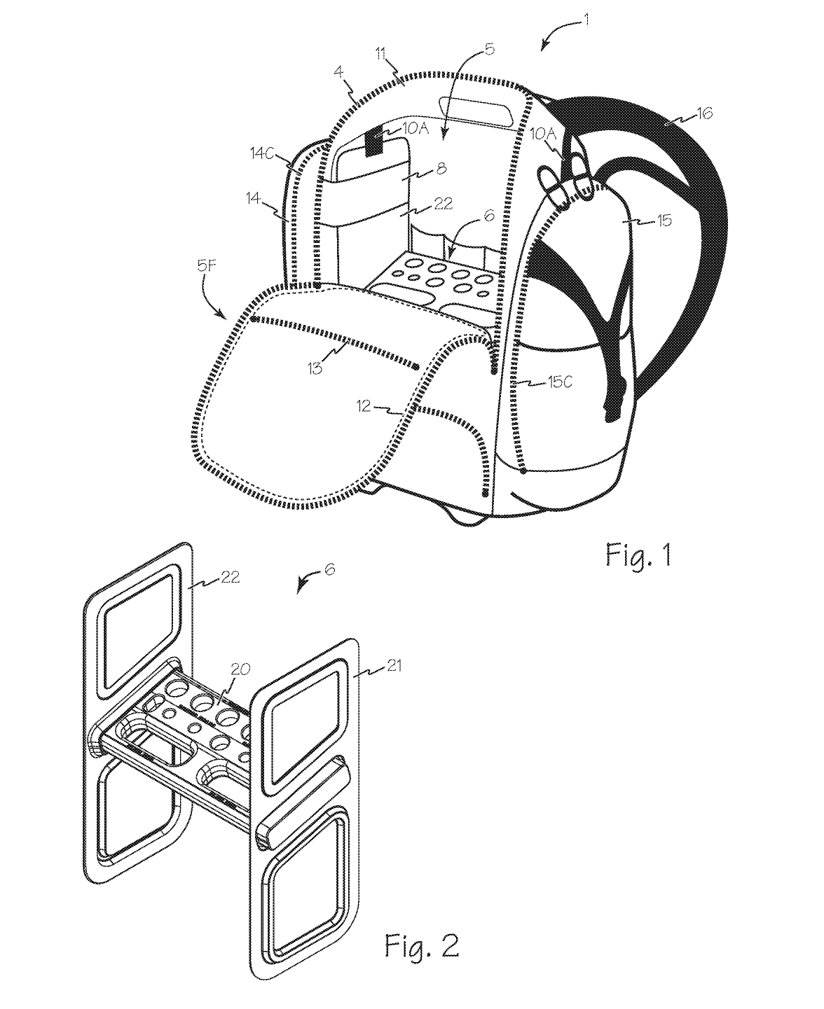

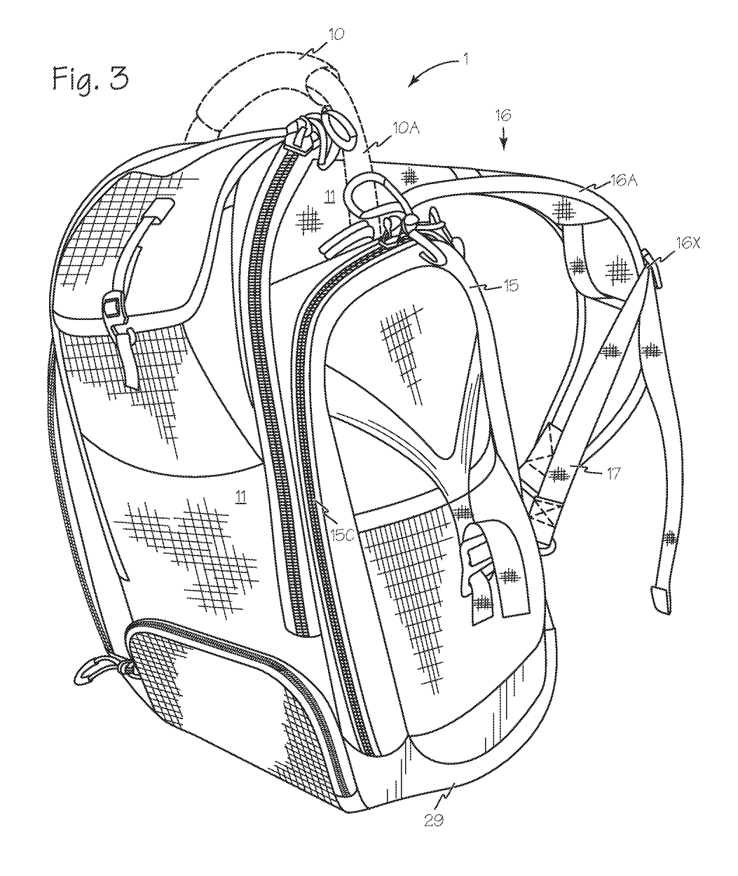

FIG. 1 is a perspective view of tool bag 1 with first closure 4 opened to expose primary compartment 5 and tool organizer/rack 6. Tool organizer/rack 6 is generally H-shaped and is secured in the tool bag by straps such as strap 8 securing the top and bottom side frames of the tool organizer/rack. Carry handle 10 (shown in FIG. 3) engages handle strap 10A which is secured to bag body 11 and to tool organizer frames 21 and 22 as illustrated. This configuration enables carry handle 10 and strap 10A to support the weight of tool organizer 6 rather that simply supporting bag body 11 to support the tool organizer and its load of tools. Tool bag body 11 is formed of any suitable synthetic material or combination of materials such as nylon, aramids and polypropylene.

Primary compartment flap 5F includes compartment 12 with closure 13. The closures on tool bag 1 such as first closure 4 and closure 13 may be zippers, hook and loop fasteners or any other suitable closure device. Tool bag 1 includes right and left side pockets 14 and 15 with closures 14C and 15C respectively. Side pockets 14 and 15 are sized, padded and covered to protect test instruments. Tool bag 1 also includes single strap carry system 16.

Referring now to FIGS. 3 through 8, primary strap 16A is attached to bag body 11 at top center point 1A and a bottom corner such as corner 2. Primary strap 16A is sized and oriented to support and balance the weight of tool bag 1 on a single user's shoulder. To further secure tool bag 1 without the use of a second conventional primary strap, secondary strap 17 is attached to corner 3 and may be removably secured to primary strap 16A using any suitable fastener such as a buckle, clip, snap, hook and loop or other such as buckle 19 at attachment point 16X.

FIG. 2 is a perspective view of tool organizer/rack 6. Tool organizer/rack 6 includes tool tray 20 secured between left side frame 21 and right side frame and 22.

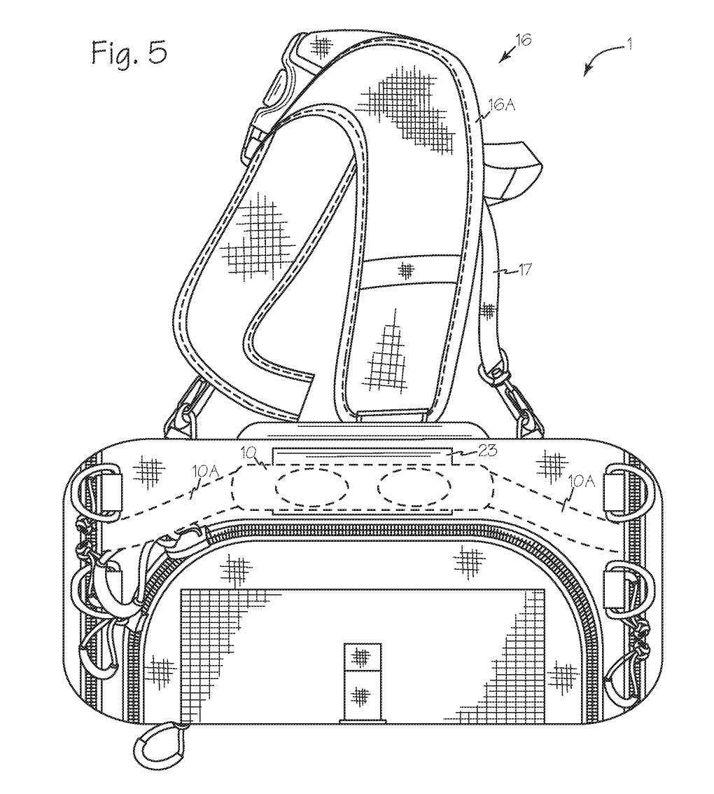

FIG. 5 is a top view of tool bag 1 illustrating magnetic part tray 23 integrated into the bag body and the configuration of single strap carry system 16 which includes primary strap 16A and secondary strap 17. As previously discussed, handle 10 is secured to bag body 11 using handle straps 10A.

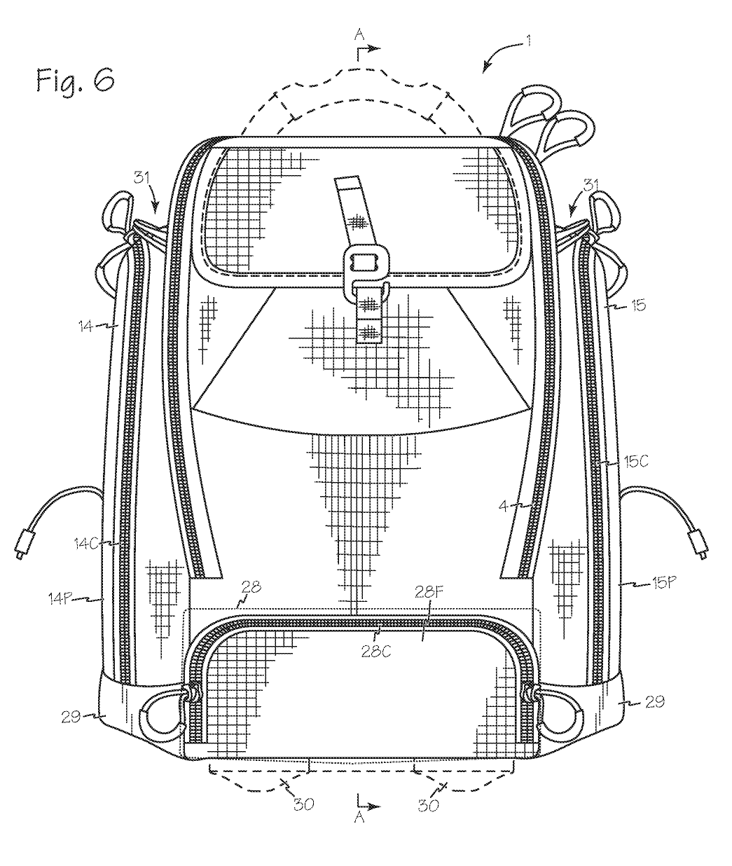

FIG. 6 is a front view of tool bag 1 illustrating flap 28F and closure 28C enclosing bottom compartment 28. Corner reinforcements 29 and feet 30 may be formed of any suitable material. Tool bag 1 also includes D-rings 31 for attaching miscellaneous equipment.

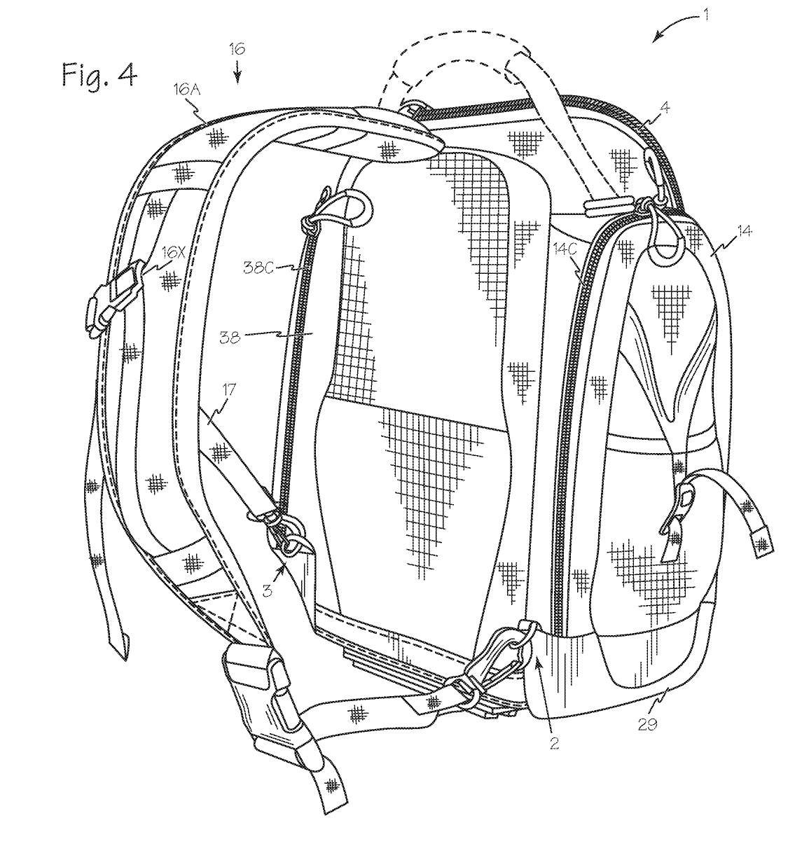

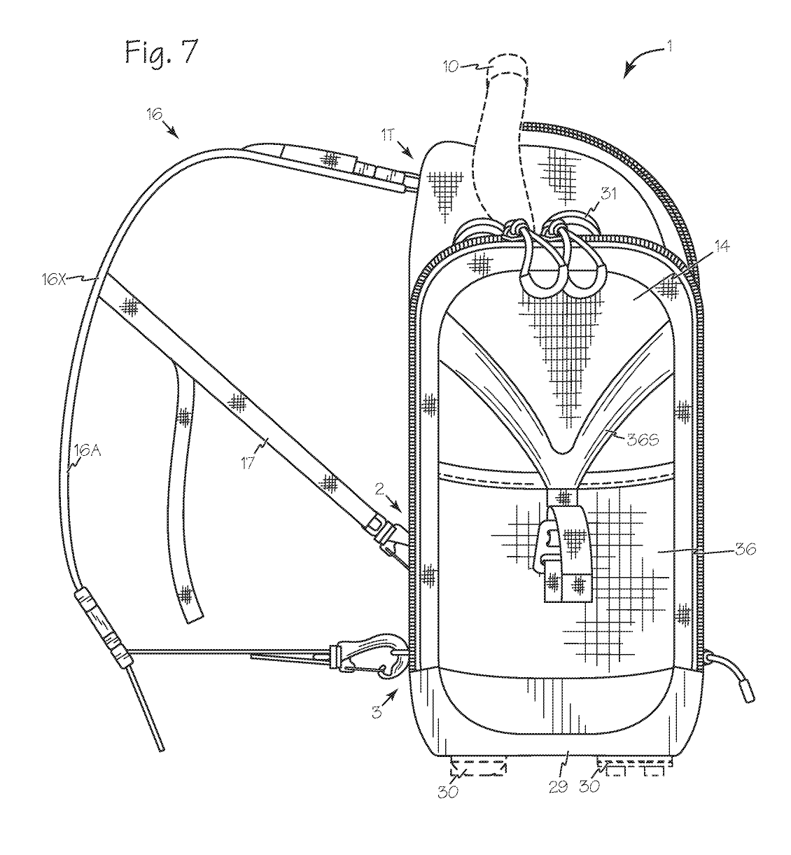

FIGS. 7 and 8 are views of the right and left side of tool bag 1. Right and left side pockets 14 and 15 incorporate outer tool pockets 36 and 37 respectively that are secured with straps 36S and 37S respectively. FIG. 4 illustrates tablet pocket 38 which is secured by closure 38C. Primary strap 16A engages tool bag 1 at top 1T and first corner 2. Secondary strap 17 engages second corner 3 and is secured to primary strap at connection point 16X.

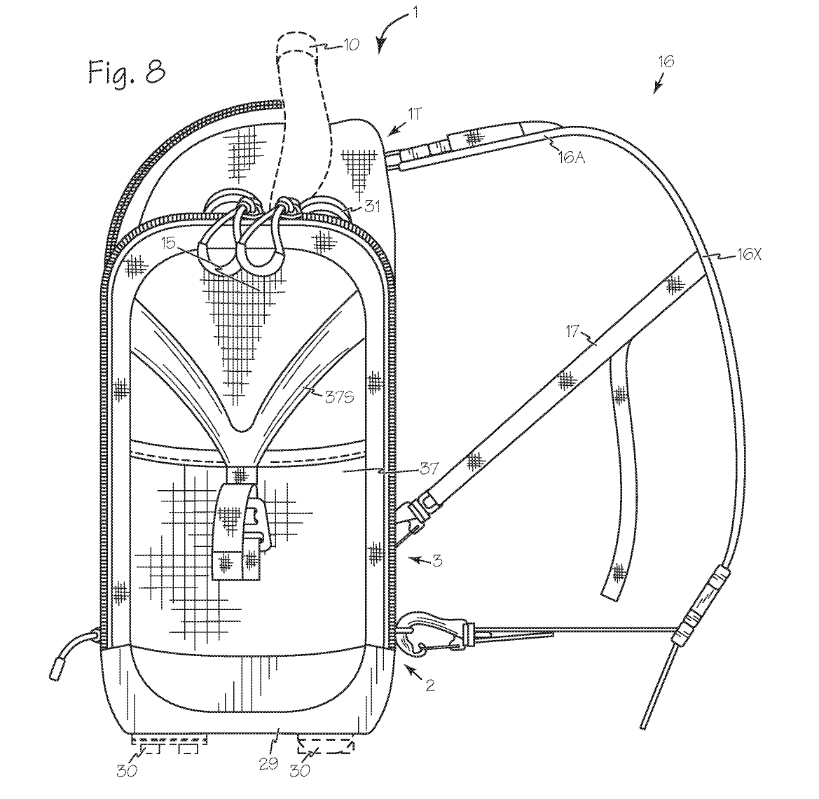

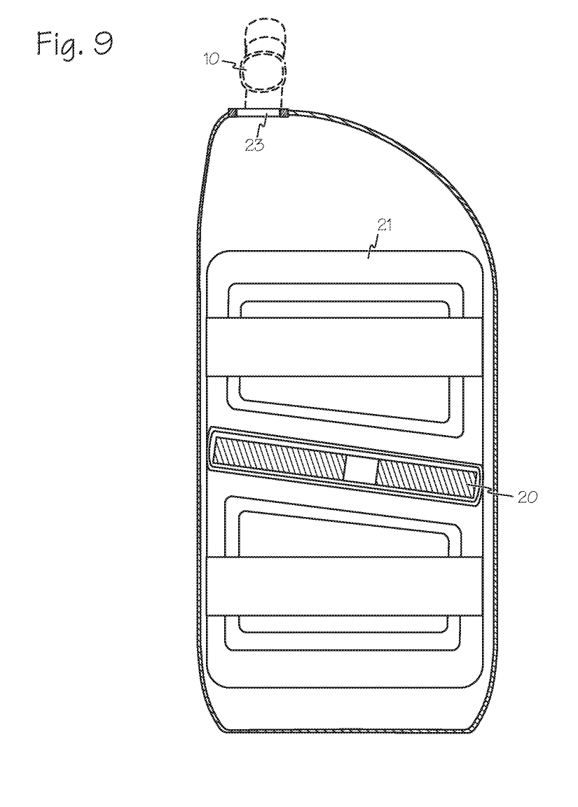

FIG. 9 is a cross-section view of the tool bag of FIG. 6 taken along A-A to illustrate the depth of magnetic part tray 23.

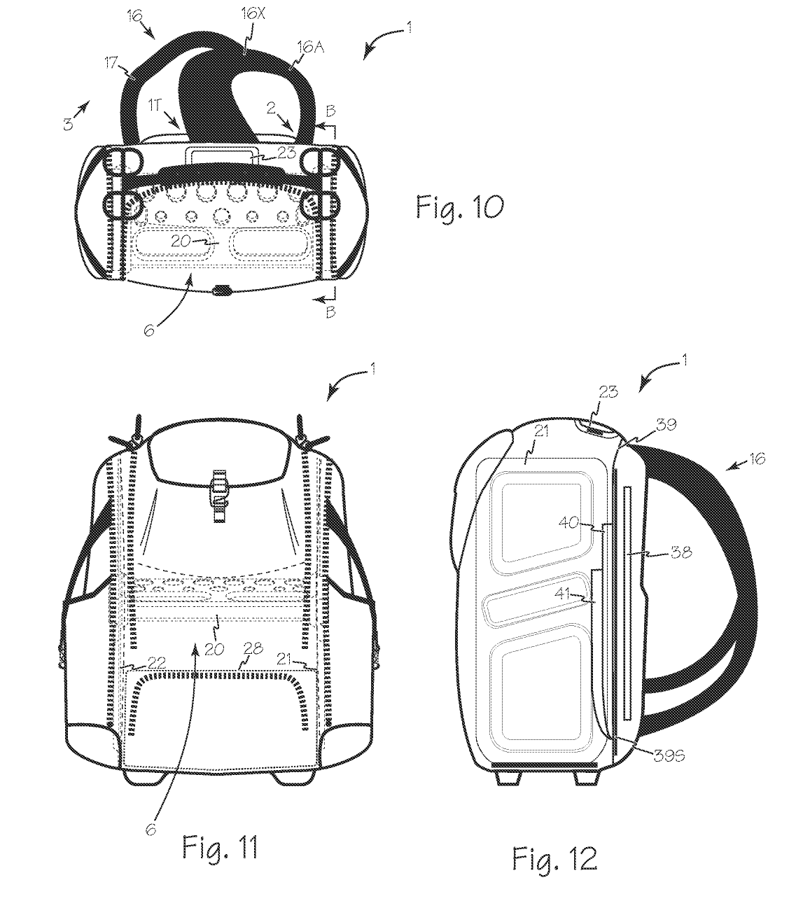

FIGS. 10 and 11 illustrate tool bag 1 from the top and front showing the location and orientation of tool organizer/rack 6 within the tool bag.

FIG. 12 is a section view of tool bag 1 taken along B-B as shown in FIG. 10. Internal divider 39 is reinforced with internal support 39S. Reinforced internal divider 39 supports first tool pockets 40 and second internal pockets 41 which are oriented and dimensioned to secure wrenches. Reinforced internal divider is adjacent to tablet pocket 38 to protect and support anything inserted into tablet pocket 38.

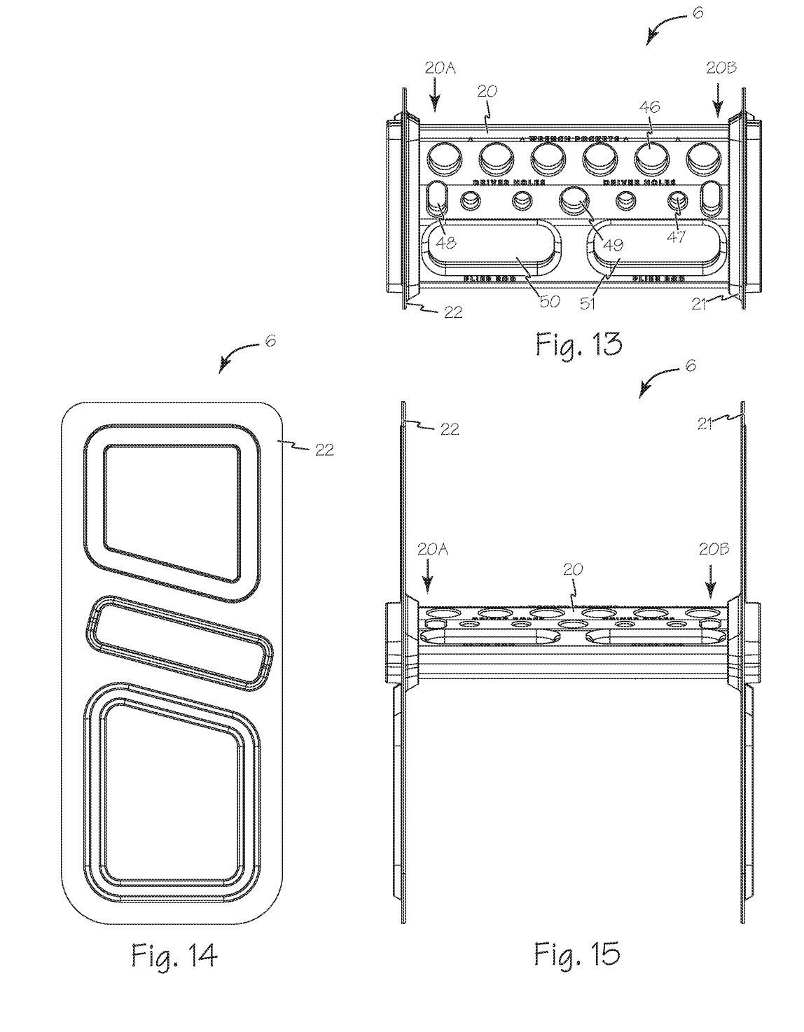

FIGS. 13, 14 and 15 illustrate top, side and front views of tool organizer/rack 6 and its component parts including side frames 21 and 22 and tool tray 20. First end 20A of tool tray 20 engages right side frame 22 and second end 20B engages left side frame 21. Tool tray 20 is formed with four different sizes of driver holes to engage many different drivers or other suitable tools. A first set of holes such as hole 46 are sized and oriented to engage and support fastener drivers. A second set of holes such as hole 47 are sized and oriented to engage and support fastener drivers with narrow shafts. An oblong driver holes 48 are sized and oriented to engage and support fastener drivers with alternate shapes. A third driver hole 49 is sized and oriented to engage and support a fastener driver or other suitable tool. Plier slots 50 and 51 are sized and oriented to engage and support pliers or other suitable tools.

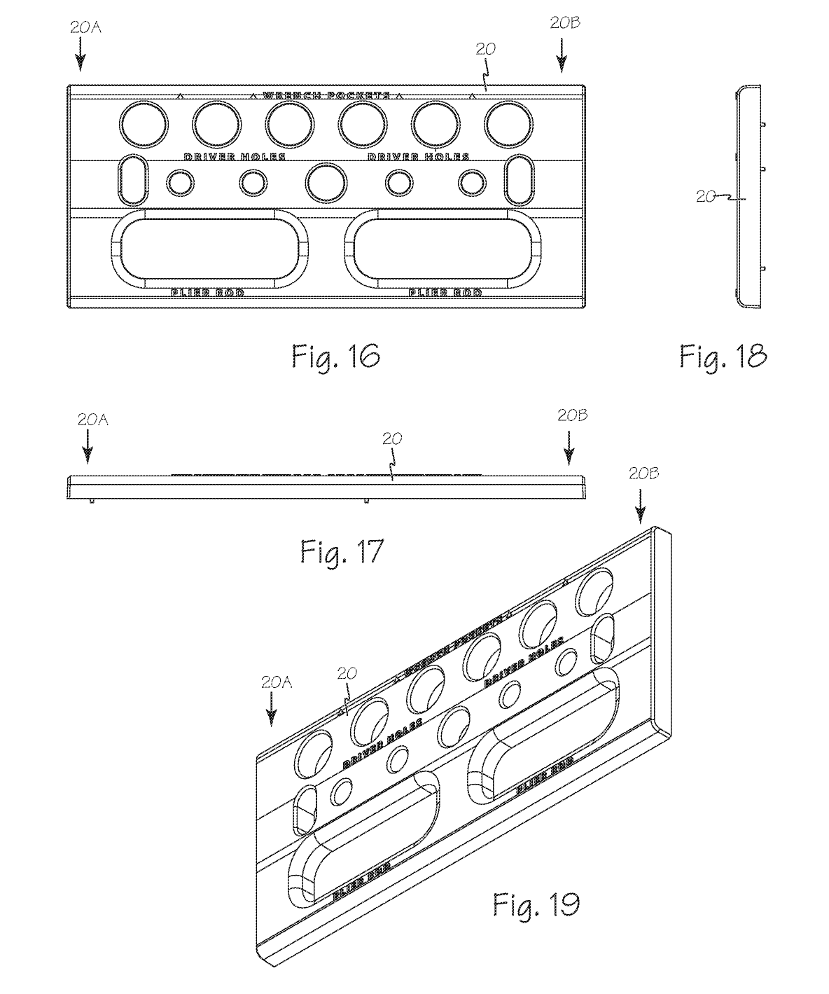

FIGS. 16, 17, 18 and 19 illustrate front, top side and perspective views of tool tray 20.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A tool bag comprising:
a tool bag body having a primary compartment and a plurality of other compartments and pockets;
a reinforced internal divider;
a tablet pocket adjacent the reinforced internal divider;
a generally H-shaped internal tool organizer secured within the primary compartment, the internal tool organizer comprising:
a left side frame;
a right side frame;
a tool tray having a first end and a second end wherein the first end engages the right side frame;
a single strap carry system secured to the bag body, the single strap carry system having only a primary strap suitable for supporting the tool bag from the top and a secondary strap for securing the side of the tool bag to the primary strap; and
a carry handle engaging handle straps which engage the bag body and the generally H-shaped internal tool organizer.

2. A tool bag comprising:
a tool bag body having a primary compartment and a plurality of other compartments and pockets;
a magnetic part tray secured to the tool bag body;
a single strap carry system secured to the bag body, the single strap carry system having only a primary strap suitable for supporting the tool bag from the top and a secondary strap for securing the side of the tool bag to the primary strap.

3. The tool bag of claim 2 further comprising a carry handle engaging handle straps which engage the bag body and a generally H-shaped internal tool organizer.
